(19) United States
(12) Patent Application Publication
(10) Pub. No.: US 2025/0312935 A1
(43) Pub. Date: Oct. 9, 2025

(54) A CUTTING ASSEMBLY

(71) Applicant: KONINKLIJKE PHILIPS N.V., EINDHOVEN (NL)

(72) Inventors: MICHEL VAN ES, GRONINGEN (NL); GUY ANTHONY BROWN, HAARLEM (NL); MICHAEL REECE JENKINS, AMSTERDAM (NL); GEERT-JAN DARWINKEL, WINSUM (NL)

(21) Appl. No.: 18/881,619

(22) PCT Filed: Jul. 4, 2023
(86) PCT No.: PCT/EP2023/068316

§ 371 Date: Jan. 6, 2025

(30) Foreign Application Priority Data
Jul. 7, 2022 (EP) 22183664.6

(51) Int. Cl. B26B 19/20; B26B 19/06

(52) U.S. Cl. CPC B26B 19/205; B26B 19/06

(57) ABSTRACT

A cutting assembly (20) for a hair cutting device (10) comprising: a guard blade (22) comprising a plurality of guard teeth (28) distributed along a top edge of the guard blade and defining an x-axis (50) passing through tips of the guard teeth, a cutting blade (24) configured to cooperate with the guard blade to cut hairs, the cutting blade comprising a plurality of cutting teeth (30) extending along a cutting edge of the cutting blade and defining a cutting axis (150) passing through tips of the cutting teeth, wherein the guard blade is assembled adjacent to the cutting blade so that: the guard blade and the cutting blade are configured to slide within a blade plane relative to one another whilst remaining in contact with one another, the guard teeth and the cutting teeth overlap, and the cutting axis parallel to the x-axis; wherein the cutting blade is configured to move reciprocally along the cutting axis relative to the guard blade, such that the cutting teeth and the guard teeth cooperate to cut hairs; and an adjustment mechanism (26) comprising an input device configured to be manipulated by a user, wherein the adjustment mechanism is configured to be switched between a neutral configuration and a y-set configuration: wherein in the y-set configuration, the input device of the adjustment mechanism is engaged with a y-gear mechanism such that manipulation of the input device forces movement of the y-gear mechanism, which moves the cutting blade along a y-axis 250, perpendicular to the x-axis and within the blade plane, relative to the guard blade to align the cutting axis with the x-axis within the blade plane; and where in in the neutral configuration, the input device is disengaged from the y-gear mechanism such that the input device is freely manipulatable without resulting in movement of the cutting blade along the y-axis relative to the guard blade.

### FIELD OF THE INVENTION

The present disclosure relates to a cutting assembly for a hair cutting device and the hair cutting device.

### BACKGROUND OF THE INVENTION

Hair cutting devices typically including a guard blade and a cutting blade which must be perfectly aligned for the best hair cutting performance. Tolerances in manufacturing and in manual replacement of cutting blades, however, can result in misalignment of the cutting blade with the guard blade.

### SUMMARY OF THE INVENTION

According to a first specific aspect, there is provided a cutting assembly for a hair cutting device, the cutting assembly comprising:
a guard blade comprising a plurality of guard teeth distributed along a top edge of the guard blade and defining an x-axis passing through tips of the guard teeth,
a cutting blade configured to cooperate with the guard blade to cut hairs, the cutting blade comprising a plurality of cutting teeth extending along a cutting edge of the cutting blade and defining a cutting axis passing through tips of the cutting teeth,
wherein guard blade is assembled adjacent to the cutting blade so that:
   the guard blade and the cutting blade are configured to slide within a blade plane relative to one another whilst remaining in contact with one another,
   the guard teeth and the cutting teeth overlap, and
   the cutting axis parallel to the x-axis;
wherein the cutting blade is configured to move reciprocally along the cutting axis relative to the guard blade, such that the cutting teeth and the guard teeth cooperate to cut hairs; and
an adjustment mechanism comprising an input device configured to be manipulated by a user, wherein the adjustment mechanism is configured to be switched between a neutral configuration and a y-set configuration:
   wherein in the y-set configuration, the input device of the adjustment mechanism is engaged with a y-gear mechanism such that manipulation of the input device forces movement of the y-gear mechanism, which moves the cutting blade along a y-axis, perpendicular to the x-axis and within the blade plane, relative to the guard blade to align the cutting axis with the x-axis within the blade plane; and
   wherein in the neutral configuration, the input device is disengaged from the y-gear mechanism such that the input device is freely manipulatable without resulting in movement of the cutting blade along the y-axis relative to the guard blade.

It may be that the input device of the adjustment mechanism comprises an elongate rod extending along a rod axis, and a wheel at an axial end of the rod. It may be that the input device is configured to be moveable along the rod axis relative to the y-gear mechanism to engage and disengage the y-gear mechanism to thereby switch the adjustment mechanism between the y-set configuration and the neutral configuration, respectively.

It may be that the y-gear mechanism comprises a first worm gear and a second worm gear, which are spaced apart along a direction parallel to the x-axis and secured by a base, wherein the base is coupled to the cutting blade. It may be that the first worm gear and the second worm gear comprise respectively a first helical worm meshed with a first worm wheel and a second helical worm meshed with a second worm wheel, such that, when simultaneously engaged by the input device in the y-set configuration, the first worm gear and the second worm gear are configured to move the cutting blade along the y-axis relative to the guard blade.

Having two worm gears spaced apart along a direction parallel to the x-axis and simultaneously engaging them in the y-set configuration means that two sides of the cutting blade can be simultaneously moved, to reduce the likelihood of accidental angular movement of the cutting blade relative to the guard blade without requiring a guide.

It may be that the rod comprises a first y-key and a second y-key, spaced apart along the rod axis by the same amount as the first worm gear and the second worm gear. It may be that the rod passes through the first helical worm and the second helical worm. It may be that in the y-set configuration, the first y-key is configured to engage with the first helical worm, and the second y-key is configured to engage with the second helical worm so that rotation of the wheel of the input device forces rotation of the first helical worm and the second helical worm, which forces corresponding rotation of the first and second worm wheel, thereby moving the cutting blade along the y-axis relative to the guard blade. It may be that in the neutral configuration, the first y-key and the second y-key are configured to disengage from the first and second helical worms so that rotation of the wheel of the input device does not move the cutting blade relative to the guard blade.

It may be that the guard blade comprises a plurality of rod holders comprising an aperture through which the rod is passed and through which the rod is moveable along the rod axis, rod axis wherein the apertures in the rod holders are elliptical to permit movement of the rod along the y-axis.

It may be that a biasing element is disposed between the guard blade and the base, which is configured to bias the base from the guard blade so that the cutting axis is biased away from the x-axis in a direction towards the guard blade, so that the cutting teeth do not protrude beyond the guard teeth. This is important to ensure safety of the mechanism. The teeth on the cutting blade are typically much sharper than those of the guard blade, and so biasing the cutting blade to prevent protrusion of the cutting teeth improves safety for a user.

It may be that the first worm wheel and the second worm wheel comprise an eccentric protrusion which is configured to engage a respective buttress on the guard blade to apply a force to the guard blade from the base opposing the force applied to the guard plate by the biasing element, to enable fine tuning of the position of the cutting axis along the y-axis relative to the guard blade by manipulating the input device.

It may be that the adjustment mechanism is further configured to be switched to an x-set configuration, wherein in the x-set configuration, the input device is disengaged from the y-gear mechanism and engaged with an x-gear mechanism which is configured to move the cutting blade along the cutting axis, such that manipulation of the input device forces movement of the x-gear mechanism which moves the cutting blade along the cutting axis relative to the guard blade.

The input device may be configured so that movement along the rod axis of the input device switches the adjustment mechanism between the y-set configuration, the x-set configuration, and the neutral configuration.

It may be that the x-gear mechanism comprises a third helical worm disposed between the first worm gear and the second worm gear, and configured to engage with a base gear of the base, such that the cutting blade is moved along the cutting axis relative to the guard blade when the third helical worm is turned by the input device.

It may be that the base gear comprises an internal thread on the base, corresponding to an external thread of the third helical worm.

It may be that the rod comprises an x-key, disposed between the first y-key and the second y-key. It may be that in the y-set configuration, the x-key is configured to disengage from the third helical worm, so that manipulation of the input device does not move the cutting blade along the cutting axis. It may be that in the x-set configuration, the x-key is configured to engage with the third helical worm, the first y-key is configured to disengage with the first helical worm of the first worm gear, and the second y-key is configured to disengage with the second helical worm of the second worm gear so that manipulation of input device forces rotation of the third helical worm, thereby moving the cutting blade along the cutting axis relative to the guard blade, and not moving the cutting blade along the y-axis relative to the guard blade. It may be that in the neutral configuration, the x-key is configured to disengage from the third helical worm so that manipulation of the input device does not move the cutting blade relative to the guard blade.

It may be that the adjustment mechanism is further configured to be switched to an angular-set configuration, wherein in the angular-set configuration, the input device is disengaged from the y-gear mechanism and engaged with an angular-gear mechanism, such that manipulation of the input device forces movement of the angular-gear mechanism which moves the cutting blade to rotate about an angular axis perpendicular to both the cutting axis and the y-axis.

It may be that the angular gear mechanism comprises a part of the y-gear mechanism.

The input device may be configured so that movement along the rod axis of the input device switches the adjustment mechanism between the y-set configuration, the angular-set configuration, and the neutral configuration. The input device may be configured so that movement along the rod axis of the input device switches the adjustment mechanism between the y-set configuration, the angular-set configuration, the x-set configuration and the neutral configuration.

It may be that the angular-gear mechanism comprises the first worm gear or the second worm gear.

It may be that in the angular-set configuration, an angular-key is configured to engage the first helical worm or the second helical worm, the first y-key is configured to disengage from the first helical worm, the second y-key is configured to disengaged from the second helical worm, and the x-key is configured to disengage from the third helical worm, so that manipulation of the input device causes angular rotation of the cutting blade relative to the guard blade, and does not move the cutting blade along the cutting axis or along the y-axis relative to the guard blade.

According to as second aspect, there is provided a hair cutting device comprising a handle; a cutting assembly according to the first aspect; and a driving mechanism configured to reciprocally move the cutting blade along the cutting axis relative to the guard blade.

These and other aspects will be apparent from and elucidated with reference to the embodiments described hereinafter.

### BRIEF DESCRIPTION OF THE DRAWINGS

Exemplary embodiments will now be described, by way of example only, with reference to the following drawings, in which:

FIG. 1 schematically shows an oblique view of an example hair cutting device;

FIG. 2 schematically shows an oblique view of an example cutting assembly of the hair cutting device;

FIG. 3 schematically shows an exploded view of the example cutting assembly; and

FIGS. 4-7 schematically show cross-sectional views of the example cutting assembly in various different settings.

### DETAILED DESCRIPTION OF THE EMBODIMENTS

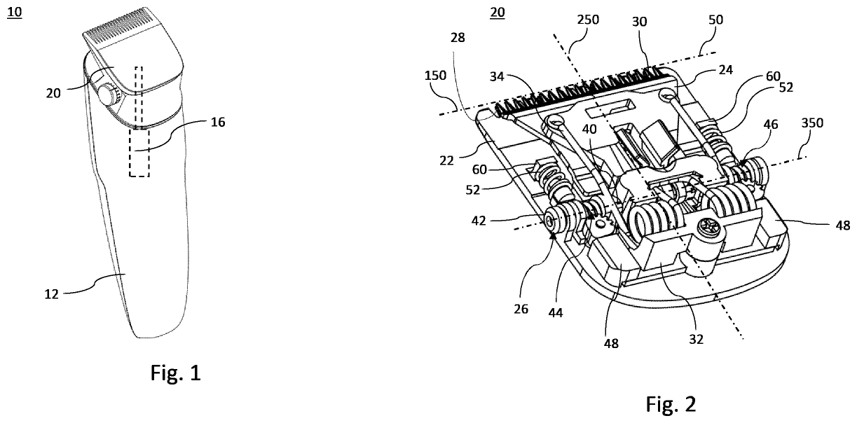

FIG. 1 shows a hair cutting device 10 comprising a handle 12 and a cutting assembly 20 which is configured to cut hairs.

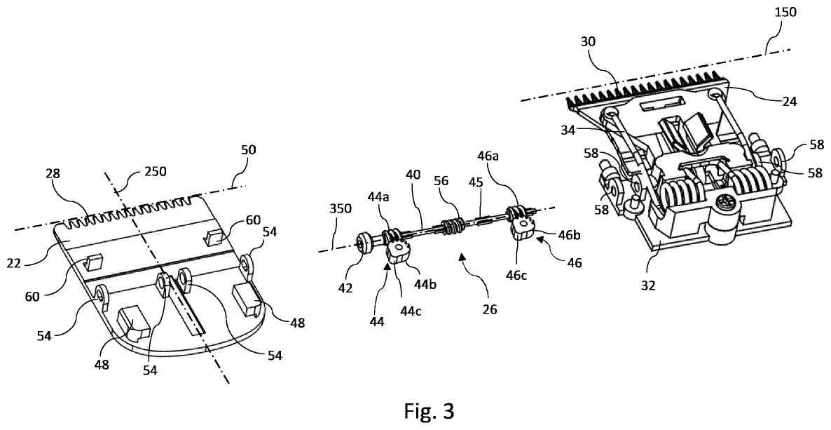

FIGS. 2 and 3 respectively show an assembled view and an exploded view of the cutting assembly 20.

The cutting assembly 20 comprises a guard blade 22, a cutting blade 24 and an adjustment mechanism 26.

The cutting blade 24 is configured to cooperate with the guard blade 22 to cut hairs. Specifically, the guard blade 22 comprises a plurality of guard teeth 28 distributed along a top edge of the guard blade 22. The guard blade 22 defines an x-axis 50 which passes through tips of the guard teeth 28. The cutting blade 24 comprises a plurality of cutting teeth 30 extending along a cutting edge of the cutting blade 24, and defining a cutting axis 150 which passes through tips of the cutting teeth 30.

The guard blade 22 and the cutting blade 24 are substantially planar and the guard blade 22 is assembled adjacent to the cutting blade 24 so that the cutting teeth 30 overlap with the guard teeth 28, and so that the guard blade 22 and the cutting blade are configured to slide within a blade plane, which is parallel to the plane of each of the guard blade 22 and the cutting blade 24, relative to one another. While sliding within the blade plane, the guard blade 22 and the cutting blade 24 are configured to remain in contact, and in this example, the cutting axis 150 is shown to be collinear with the x-axis 50 in FIG. 2. In some examples, the cutting axis 150 may not be collinear with the x-axis 50, but may be configured to be parallel to the x-axis 50. In other examples, the cutting axis 150 may not be parallel to the x-axis 50, but is configured to parallel to the x-axis 50 for best alignment in use. The adjustment mechanism may therefore be configured to correct an alignment of the cutting axis 150 so that it is parallel to the x-axis 50.

In use, the cutting blade 24 is configured to move reciprocally along the cutting axis 150 relative to the guard blade 22, such that the cutting teeth 30 and the guard teeth 28 cooperate to cut hairs. Referring back to FIG. 1, the hair cutting device 10 comprises a driving mechanism 16 which is configured to reciprocally move the cutting blade 24 along the cutting axis 150 relative to the guard blade 22.

Referring back to FIGS. 2 and 3, in this example, the cutting assembly 20 comprises a base 32 which is coupled to the cutting blade 24 and constrained on the guard blade 22.

The base 32 is constrained along the x-axis 50 relative to the guard blade 22 by a pair of buttresses 48 protruding from the guard blade 22, each buttress 48 having an overhang. Sides of the base 32 are slotted under the overhang of the buttresses 48 to constrain relative movement of the guard blade 22 and the base 32 in a direction perpendicular to the blade plane. The sides of the base 32 also abut the respective buttresses 48 so that the buttresses 48 prevent relative movement of the base 32 and the guard blade 22 in a direction parallel to the x-axis 50. The base 32 is moveable along a y-axis 250 relative to the guard blade 22, where the y-axis 250 is perpendicular to the x-axis 50, and parallel to the blade plane. The base 32 is biased along the y-axis 250 relative to the guard blade 22 by a biasing clement 52 in the form of a pair of compression springs 52 which respectively act between a pair of stops 60 of the guard blade 22 and the base 32 to bias the base 32 away from the guard teeth 28. A counteracting force along the y-axis 250, to the force applied by the biasing element 52, is provided by the base 32 abutting the buttresses 48, which will be described in more detail below, to provide adjustment of the base 32 along the y-axis 250 relative to the guard blade 22.

The cutting blade 24 is configured to move reciprocally along the cutting axis 150 relative to the base 32. In this example, the cutting blade 24 is constrained to move only along the cutting axis 150 relative to the base 32, such that it does not move along the y-axis 250 relative to the base 32. Therefore, when the base 32 is moved along the y-axis 250 relative to the guard blade 22, the cutting blade 24 is also moved along the y-axis 250 relative to the guard blade 22 by a corresponding amount. The cutting blade 24 is constrained so that it cannot move relative to the base 32 along the y-axis 250 by abutting the base 32 and being held in place by a double-sided torsional spring element 34.

Therefore, biasing the base 32 with the biasing clement 52 towards a bottom edge of the guard blade 22 (opposing the top edge of the guard blade 22 where the guard teeth 28 are distributed) also biases the cutting blade 24 towards the bottom edge of the guard blade 22. This biases the cutting axis 150 away from the x-axis 50 in a direction towards the bottom edge of the guard blade 22, so that the cutting teeth 30 do not protrude beyond the guard teeth 28. Biasing the cutting blade 24 in this direction is an important safety feature of the cutting assembly 20. The cutting teeth 30 are typically much sharper than the guard teeth 28, and so biasing the cutting blade 24 to prevent protrusion of the cutting teeth 30 improves safety for a user.

The double-sided torsional spring element 34 is coupled between the base 32 and two points on the cutting blade 24 spaced along a direction parallel to the cutting axis 150. The torsional spring clement 34 simultaneously prevents the cutting blade 24 from moving away from the base 32 along the y-axis 250, biases the cutting blade 24 against the guard blade 22 perpendicular to the blade plane to ensure that the guard blade 22 and the cutting blade 24 remain in contact, and biases the cutting blade 24 towards a central position along the cutting axis 150 relative to the base 32.

The adjustment mechanism 26 comprises an input device which is configured to be manipulated by the user in order to adjust the cutting assembly 20. In this example, the input device comprises an elongate rod 40 extending along a rod axis 350 and a wheel 42 at an axial end of the rod 40. In this example, the rod 40 comprises a plurality of keys 45 (best seen in FIG. 3) spaced apart along the rod 40. The keys 45 are specially shaped protrusions from the rod 40 which cooperate with corresponding key slot in gear sets to engage respective gear sets. In this example, the rod axis 350 is parallel to the x-axis 50 and the cutting axis 150.

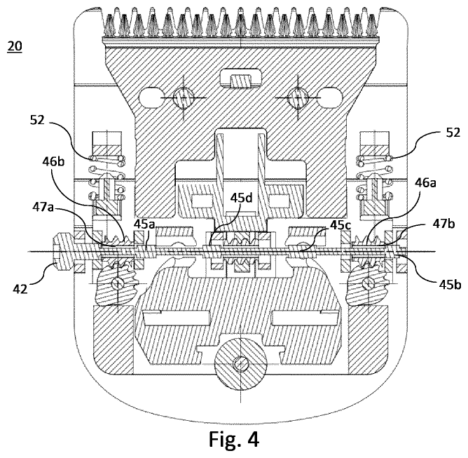

The adjustment mechanism 26 in this example is configured to be switched between a y-set configuration, an angular-set configuration, an x-set configuration and a neutral configuration which will be described in more detail below with reference to FIGS. 4-7. In some examples, the adjustment mechanism may be configured to switch between only the y-set configuration and the neutral configuration. In some examples, the adjustment mechanism may be configured to switch between only the y-set configuration, the x-set configuration, and the neutral configuration. In other examples, the adjustment mechanism may be configured to switch between only the y-set configuration, the angular configuration and the neutral configuration.

In this example, the adjustment mechanism 26 is configured to switch between the configurations by moving the input device along the rod axis 350.

In this example, the adjustment mechanism 26 comprises a first worm gear 44 and a second worm gear 46 which are spaced apart along a direction parallel to the rod axis 350. The first worm gear 44 comprises a first helical worm 44a and a first worm wheel 44b which are meshed together. The second worm gear 46 comprises a second helical worm 46a and a second worm wheel 46b which are meshed together (best seen in FIG. 3). The rod 40 passes through the first helical worm 44a and the second helical worm 46a, so that the first helical worm 44a and the second helical worm 46a are spaced apart along the rod axis 350.

In this example, the first worm wheel 44b and the second worm wheel 46b are secured to the base 32 on opposing sides of the base, so that they rotate about an axis perpendicular to both the x-axis 50 and the y-axis 250. The first worm wheel 44b and the second worm wheel 46b each comprise eccentric protrusions 44c, 46c which are configured to engage respective buttresses 48 protruding from the guard blade 22 to provide a force to the base 32 along the y-axis 250 counteracting the force applied by the compression springs 52 to the base 32. Rotation of the first worm wheel 44b and the second worm wheel 46b in the same direction therefore either pushes the buttresses 48 of the guard blade 22 away from the cutting edge of the cutting blade 24 or allows the buttresses 48 to come closer to the cutting edge of the cutting blade 24 under action of the compression springs 52, so that the cutting axis 150 is controllably moved along the y-axis 250.

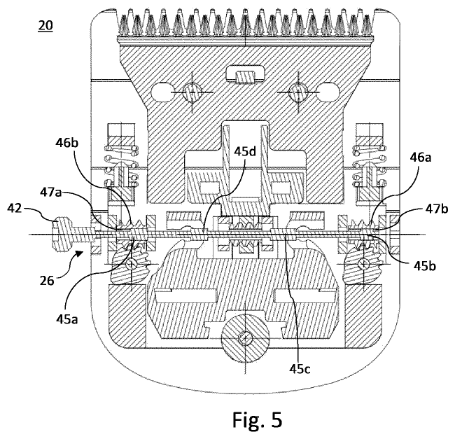

In this example, the first worm gear 44 and the second worm gear 46 therefore together form a y-gear mechanism which, when engaged respectively by a first y-key 45a and a second y-key 45b of the input device (i.e., the rod 40), best seen in FIGS. 4-7, enables the cutting blade 24 to be moved along the y-axis relative to the guard blade 22 to fine tune alignment of the cutting axis 150 with the x-axis 50, upon manipulation of the input device. This will be explained in more detail below with reference to FIG. 5.

In this example, the guard blade 22 comprises a plurality of guard rod holders 54 (best seen in FIG. 3) and the base 32 comprises a plurality of base rod holders 58. Each of the rod holders 54, 58 comprises an aperture through which the rod 40 is passed and through which the rod 40 is moveable along the rod axis 350. In this example, the first helical worm 44a is disposed between a pair of base rod holders 58 and the second helical worm 46a is disposed between another pair of base rod holders 58, spaced apart along a direction parallel to the x-axis 50, to secure each helical worm 44a, 46a in place along the rod axis 350. The apertures in the guard rod holders 54 are elliptical, with the longer dimension parallel to the y-axis 250, to permit movement of the rod 40 along the y-axis 250 relative to the guard blade 22.

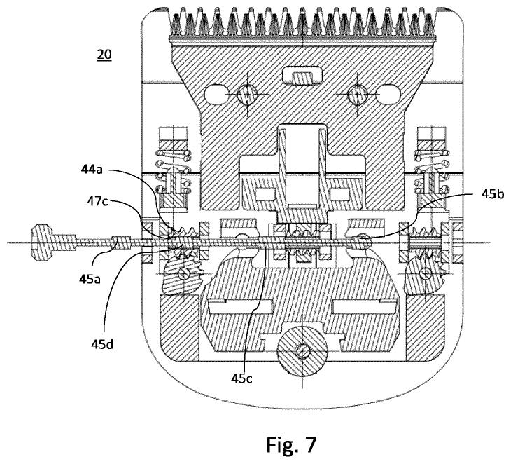

In this example, the first worm gear 44 by itself (without the second worm gear 46) forms an angular-gear mechanism which, when engaged by a key 45 of the input device, enables the cutting blade 24 to be rotated relative to the guard blade 22 about an angular axis, which is perpendicular to both the x-axis 50 and the y-axis 250, upon manipulation of the input device. This will be explained in more detail with reference to FIG. 7. In other examples, the second worm gear 46 by itself may form the angular-gear mechanism. Therefore, the angular-gear mechanism may comprise a part of the y-gear mechanism. In other examples, there may be a completely separate gear mechanism which is used to adjust the angle of the cutting blade 24 relative to the guard blade 22. In further examples, there may be no angular-gear mechanism.

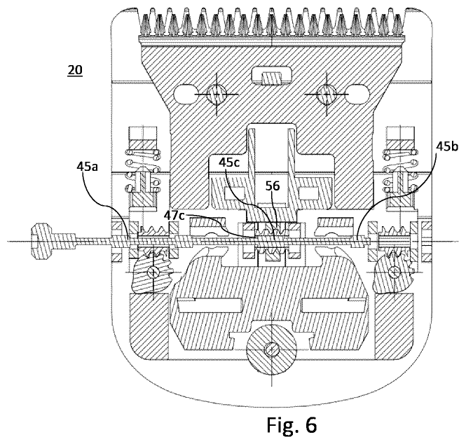

In this example, the adjustment mechanism 26 comprises a third helical worm 56 which, in this example, is disposed between the first helical worm 44a and the second helical worm 46a. The rod 40) also passes through the third helical worm 56. The third helical worm 56 is configured to engage with a base gear of the base 32 which in this example is an internal thread (not shown) on the base 32 which meshes with an external thread on the third helical worm 56 so that rotation of the third helical worm 56 results in movement of the cutting blade 24 along the cutting axis 150 relative to the guard blade 22. In other examples, the third helical worm may engage with a rack on the base extending parallel to the x-axis 50 to enable movement of the cutting blade along the cutting axis 150 (parallel to the x-axis 50) relative to the guard blade 22. In this example, the third helical worm 56 and the base gear form an x-gear mechanism which, when engaged by an x-key 45c of the input device (i.e., the rod 40)), enables the cutting blade 24 to be moved along the x-axis relative to the guard blade 22, upon manipulation of the input device. This will be explained in more detail below with reference to FIG. 6.

FIG. 4 shows the cutting assembly in the neutral configuration. In the neutral configuration the input device is disengaged from the y-gear mechanism, the angular gear mechanism and the x-gear mechanism, so that the input device can be manipulated freely (i.e., the wheel 42 can be rotated freely) without resulting in movement of the cutting blade 24 relative to the guard blade 22 along the y-axis 250), or the cutting axis 150, or any movement by angular rotation.

The first helical worm 44a, the second helical worm 46a, and the third helical worm 56 are all locked in place by friction between the components which is increased by the biasing element 52 pushing the components together.

FIG. 5 shows the cutting assembly 20 in the y-set configuration in which the wheel 42 is pulled away from the guard blade 22 and the cutting blade 24 along the rod axis 350 to switch the adjustment mechanism 26 from the neutral configuration to the y-set configuration, so that the adjustment mechanism 26 is engaged with the y-gear mechanism. In this example, the y-gear mechanism is engaged by the first y-key 45a engaging a first key slot 47a in the first helical worm 44a, and the second y-key 45b engaging a second key slot 47b in the second helical worm 46a. The keys 45 may be rectangular protrusions from the rod 40) which interlock with corresponding rectangular slots in the helical worms 44a, 46a, 56. In other examples, the keys 45 and corresponding interlocking slots may comprise a many-sided cross-section, for example a hexagonal cross-section or a cross-section having more than 6 sides, such as 10 sides. Alternatively, the cross-section may be an angularly repeated cross-section, such as a spike which is repeated angularly many times to form a star shape. The more repeated angular sections the cross-section has, the more likely that rotation of the rod 40 about the rod axis 350 will allow the rod 40 to be moved along the rod axis 350 to interlock with a corresponding slot.

The first y-key 45a and the second y-key 45b are spaced apart along the rod axis 350 by the same amount as the first worm gear 44 and the second worm gear 46 (or by the same amount as the first helical worm 44a and the second helical worm 46a) so that the first worm gear 44 and the second worm gear 46 can be simultaneously engaged and disengaged by moving the input device along the rod axis 350 relative to the base 32, thereby moving the first y-key 45a and the second y-key 45b relative to the first worm gear 44 and the second worm gear 46.

In the y-set configuration, rotation of the wheel 42 of the input device forces rotation of the first helical worm 44a and the second helical worm 46a, which forces corresponding rotation of the first worm wheel 44b and second worm wheel 46b, thereby moving the cutting blade 24 along the y-axis 250 relative to the guard blade 22.

The y-gear mechanism is disengaged by all keys 45a-d disengaging from either one or both of the first key slot 47a or the second key slot 47b, as is shown in FIG. 4, so that rotation of the wheel 42 does not move the cutting blade 24 relative to the guard blade 22 along the y-axis 250.

Having two worm gears spaced apart along a direction parallel to the x-axis 50 and simultaneously engaging them in the y-set configuration means that two sides of the cutting blade 24 can be simultaneously moved, to reduce the likelihood of accidental angular movement of the cutting blade 24 relative to the guard blade 22 without requiring a guide.

FIG. 6 shows the cutting assembly 20 in the x-set configuration in which the wheel 42 is pulled out, away from the guard blade 22 and the cutting blade 24, along the rod axis 350 further from the y-set configuration so that the adjustment mechanism 26 is disengaged from the y-gear mechanism and so that the adjustment mechanism 26 is engaged with the x-gear mechanism. In this example, the x-gear mechanism is engaged by the x-key 45c engaging a third key slot 47c in the third helical worm 56. The x-key 45c is disposed between the first y-key 45a and the second y-key 45b.

In the x-set configuration, rotation of the wheel 42 of the input device forces rotation of the third helical worm 56, which moves the cutting blade 24 along the cutting axis 150 relative to the guard blade 22. Since the y-gear mechanism is disengaged in the x-set configuration, manipulation of the wheel 42 does not move the cutting blade 24 along the y-axis 250 relative to the guard blade 22.

The x-gear mechanism is disengaged by all keys 45 disengaging from the third key slot 47c, such as shown in the neutral configuration in FIG. 4, so that rotation of the wheel 42 does not move the cutting blade 24 relative to the guard blade 22 along the cutting axis 150 (or the x-axis 50).

Referring back to FIG. 5, in the y-set configuration, the x-key 45c is configured to disengage from the third helical worm 56, so that manipulation of the input device does not move the cutting blade 24 along the cutting axis 150 relative to the guard blade 22, but only moves the cutting blade 24 along the y-axis 250 relative to the guard blade 22.

FIG. 7 shows the cutting assembly 20 in the angular-set configuration in which the wheel 42 is pulled out along the rod axis 350 further from the x-set configuration so that the adjustment mechanism 26 is disengaged from the y-gear mechanism and the x-gear mechanism and so that the adjustment mechanism 26 is engaged with the angular-gear mechanism.

In this example, the angular-gear mechanism is engaged by the angular-key 45d engaging the first key slot 47a in the first helical worm 44a. In this example, the angular-key 45d is disposed between the first y-key 45a and the second y-key 45b. In this example, the angular-key 45d is disposed between the first y-key 45a and the x-key 45c.

In the angular-set configuration, rotation of the wheel 42 of the input device forces rotation of the first helical worm 44a, which forces rotation of the first worm wheel 44b which causes angular rotation of the cutting blade 24 relative to the guard blade 22. Since the y-gear mechanism and the x-gear mechanism are disengaged in the angular-set configuration, manipulation of the wheel 42 does not move the cutting blade 24 along the y-axis 250 relative to the guard blade 22, or along the x-axis 50 or cutting axis 150.

Referring back to FIGS. 5 and 6, in the y-set configuration and in the x-set configuration, the angular-key 45d is configured to disengage from the first helical worm 44a, so that manipulation of the input device does not angularly rotate the cutting blade 24 relative to the guard blade 22.

In this example, switching between the neutral configuration, the y-set configuration, the x-set configuration and the angular-set configuration, or any suitable combination of these configurations, is achieved by pulling the rod 40 along the rod axis 350 to engage and disengage various keys on the rod 40 with the y-gear mechanism, the x-gear mechanism and the angular gear mechanism. Although the input device in this example has been described as an elongate rod with a wheel, in other examples, the input device may any suitable form of input which can be manipulated by a user to switch the adjustment mechanism between the y-set configuration and the neutral configuration, and optionally also the x-set configuration and/or the angular configuration. In further examples, the input device, such as a rod and wheel may be disposed at any angle relative to the blade, such the rod axis of the rod extending in a direction perpendicular to the x-axis or the cutting axis, and parallel to the y-axis, to enable movement of the cutting blade along the y-axis when the adjustment mechanism is engaged with a corresponding y-gear mechanism.

It will be appreciated that the spacing of the keys on the input device may be adapted to suit any order or combination of configurations. It will also be appreciated that, in some examples, there may not be a wheel 42 on the end of a rod, and instead a user may be able to manipulate the rod 40 by itself. The wheel 42 improves the ergonomics of the adjustment mechanism 26 for the user by making it easier to grip and turn the rod 40, but the wheel could be any suitable feature which makes it easier to grip and turn the rod.

For the best shave, the cutting axis 150 should be aligned as closely as possible to the x-axis 50 along the y-axis. Therefore, being able to finely adjust the position of the cutting blade 24 along the y-axis 250 is very useful. Further, being able to switch between a neutral configuration and a y-set configuration means that accidental movement of the cutting blade 24 relative to the guard blade 22 by accidental manipulation of the input device can be avoided simply by placing the adjustment mechanism 26 in the neutral configuration. Furthermore, by being able to switch between other configurations, the position of the cutting blade 24 relative to the guard blade 22 can be finely tuned to an optimal position because each direction can be independently controlled.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A cutting assembly for a hair cutting device, the cutting assembly comprising:
a guard blade comprising a plurality of guard teeth distributed along a top edge of the guard blade and defining an x-axis passing through tips of the guard teeth,
a cutting blade configured to cooperate with the guard blade to cut hairs, the cutting blade (24) comprising a plurality of cutting teeth extending along a cutting edge of the cutting blade and defining a cutting axis passing through tips of the cutting teeth,
wherein guard blade is assembled adjacent to the cutting blade so that:
the guard blade and the cutting blade are configured to slide within a blade plane relative to one another whilst remaining in contact with one another,
the guard teeth and the cutting teeth overlap, and
the cutting axis parallel to the x-axis;
wherein the cutting blade is configured to move reciprocally along the cutting axis relative to the guard blade, such that the cutting teeth and the guard teeth cooperate to cut hairs; and
an adjustment mechanism comprising an input device configured to be manipulated by a user, wherein the adjustment mechanism is configured to be switched between a neutral configuration and a y-set configuration:
wherein in the y-set configuration, the input device of the adjustment mechanism is engaged with a y-gear mechanism such that manipulation of the input device forces movement of the y-gear mechanism, which moves the cutting blade along a y-axis, perpendicular to the x-axis and within the blade plane, relative to the guard blade to align the cutting axis with the x-axis within the blade plane; and
wherein in the neutral configuration, the input device is disengaged from the y-gear mechanism such that the input device is freely manipulatable without resulting in movement of the cutting blade along the y-axis relative to the guard blade.

2. A cutting assembly according to claim 1, wherein the input device of the adjustment mechanism comprises an elongate rod extending along a rod axis, and a wheel at an axial end of the rod, wherein the input device is configured to be moveable along the rod axis relative to the y-gear mechanism to engage and disengage the y-gear mechanism to thereby switch the adjustment mechanism between the y-set configuration and the neutral configuration, respectively.

3. A cutting assembly according to claim 1, wherein the y-gear mechanism comprises a first worm gear and a second worm gear, which are spaced apart along a direction parallel to the x-axis and secured by a base, wherein the base is coupled to the cutting blade, and wherein the first worm gear and the second worm gear comprise respectively a first helical worm meshed with a first worm wheel and a second helical worm meshed with a second worm wheel, such that, when simultaneously engaged by the input device in the y-set configuration, the first worm gear and the second worm gear are configured to move the cutting blade along the y-axis relative to the guard blade.

4. A cutting assembly according to claim 2, wherein the rod comprises a first y-key and a second y-key, spaced apart along the rod axis by the same amount as the first worm gear and the second worm gear, wherein the rod passes through the first helical worm and the second helical worm, and wherein:
in the y-set configuration, the first y-key (45a) is configured to engage with the first helical worm, and the second y-key is configured to engage with the second helical worm so that rotation of the wheel of the input device forces rotation of the first helical worm and the second helical worm, which forces corresponding rotation of the first and second worm wheel, thereby moving the cutting blade along the y-axis relative to the guard blade; and
in the neutral configuration, the first y-key and the second y-key are configured to disengage from the first and second helical worms so that rotation of the wheel of the input device does not move the cutting blade relative to the guard blade.

5. A cutting assembly according to claim 3, wherein the guard blade comprises a plurality of rod holders comprising an aperture through which the rod is passed and through which the rod is moveable along the rod axis, rod axis wherein the apertures in the rod holders are elliptical to permit movement of the rod along the y-axis.

6. A cutting assembly according to claim 3, wherein a biasing element is disposed between the guard blade and the base, which is configured to bias the base from the guard blade so that the cutting axis is biased away from the x-axis in a direction towards the guard blade, so that the cutting teeth do not protrude beyond the guard teeth.

7. A cutting assembly according to claim 6, wherein the first worm wheel and the second worm wheel comprise an eccentric protrusion which is configured to engage a respective buttress on the guard blade to apply a force to the guard blade from the base opposing the force applied to the guard plate by the biasing element, to enable fine tuning of the position of the cutting axis along the y-axis relative to the guard blade by manipulating the input device.

8. A cutting assembly according to claim 1, wherein the adjustment mechanism is further configured to be switched to an x-set configuration, wherein in the x-set configuration, the input device is disengaged from the y-gear mechanism and engaged with an x-gear mechanism which is configured to move the cutting blade along the cutting axis, such that manipulation of the input device forces movement of the x-gear mechanism which moves the cutting blade along the cutting axis relative to the guard blade.

9. A cutting assembly according to claim 3, wherein the x-gear mechanism comprises a third helical worm disposed between the first worm gear and the second worm gear, and configured to engage with a base gear of the base, such that the cutting blade is moved along the cutting axis relative to the guard blade when the third helical worm is turned by the input device.

10. A cutting assembly according to claim 9, wherein the base gear comprises an internal thread on the base, corresponding to an external thread of the third helical worm.

11. A cutting assembly according to claim 4, wherein the rod comprises an x-key, disposed between the first y-key and the second y-key, wherein:
in the y-set configuration, the x-key is configured to disengage from the third helical worm, so that manipulation of the input device does not move the cutting blade along the cutting axis;
in the x-set configuration, the x-key is configured to engage with the third helical worm, the first y-key is configured to disengage with the first helical worm of the first worm gear (44), and the second y-key is configured to disengage with the second helical worm of the second worm gear so that manipulation of input device forces rotation of the third helical worm, thereby moving the cutting blade along the cutting axis relative to the guard blade, and not moving the cutting blade along the y-axis relative to the guard blade; and
in the neutral configuration, the x-key is configured to disengage from the third helical worm so that manipulation of the input device does not move the cutting blade relative to the guard blade.

12. A cutting assembly according to claim 1, wherein the adjustment mechanism is further configured to be switched to an angular-set configuration, wherein in the angular-set configuration, the input device is disengaged from the y-gear mechanism and engaged with an angular-gear mechanism, such that manipulation of the input device forces movement of the angular-gear mechanism which moves the cutting blade to rotate about an angular axis perpendicular to both the cutting axis and the y-axis.

13. A cutting assembly according to claim 12, wherein the angular gear mechanism comprises a part of the y-gear mechanism.

14. A cutting assembly according to claim 12, wherein:
in the angular-set configuration, an angular-key is configured to engage the first helical worm or the second helical worm, the first y-key is configured to disengage from the first helical worm, the second y-key is configured to disengaged from the second helical worm (46a), and the x-key is configured to disengage from the third helical worm, so that manipulation of the input device causes angular rotation of the cutting blade relative to the guard blade, and does not move the cutting blade along the cutting axis or along the y-axis relative to the guard blade.

15. A hair cutting device comprising:
a handle;
a cutting assembly according to any preceding claim; and
a driving mechanism configured to reciprocally move the cutting blade along the cutting axis relative to the guard blade.
